(19) United States
(12) Patent Application Publication
(10) Pub. No.: US 2012/0215603 A1
(43) Pub. Date: Aug. 23, 2012

(54) SYSTEM AND METHOD FOR GENERATING MERCHANT DISCOUNT DEALS HAVING PHILANTHROPIC ADVERTISING AND ASSOCIATED DONATIONS TO AN ORGANIZATION

(75) Inventors: Gianluca PIVATO, Washington, DC (US); Claudio BAZZICHELLI, Washington, DC (US)

(73) Assignee: PIVATO CONSULTING, INC., Washington, DC (US)

(21) Appl. No.: 13/398,341

(22) Filed: Feb. 16, 2012

Related U.S. Application Data
(60) Provisional application No. 61/444,423, filed on Feb. 18, 2011.

(51) Int. Cl. G06Q 30/02

(52) U.S. Cl. 705/14.16; 705/14.1

(57) ABSTRACT

A method and system for generating one or more merchant discount deals having philanthropic advertising and associated donations to one or more organizations. The method includes selecting one or more merchant offers and selecting the one or more organizations. Additionally, the method includes creating the one or more merchant discount deals using a processor of a computing device, by associating an offer of the one or more offers with an organization of the one or more organizations, wherein each merchant discount deal has an associated discount to a user and a base donation amount to one of the one or more organizations and displaying the one or more merchant discount deals.

### CROSS REFERENCE TO RELATED APPLICATION

The present application claims priority to U.S. Provisional Application No. 61/444,423 filed on Feb. 18, 2011, the disclosure of which is expressly incorporated by reference herein in its entirety.

### BACKGROUND OF THE INVENTION

1. Field of the Invention

The present invention relates to a method and system for generating merchant discount deals, and more specifically, a method and system for generating merchant discount deals having philanthropic advertising and associated donations to an organization.

2. Description of the Related Art

Online group buying web sites allow consumers to purchase goods or services at a discount generating savings for the buyers and bring new customers for the merchants by exploiting the wide reach of the internet.

Typically the average savings generated by the discounts are relatively small and generally of little significance for the individual consumer: saving, for example, $20, $50, or even $100.

Purchase-linked philanthropic advertising is an advertising technique that ties purchases from, e.g., a merchant or corporation to a charitable donation to a nonprofit organization, usually selected by the merchant or corporation. Corporate Philanthropy marketing is generally deployed in the form of a fixed amount donation directly to a cause/organization, as a grant-matching program where the sponsoring corporation augments funds raised during a fundraising drive, or as a generic purchase-linked donation program. For example, a sponsoring corporation advertises that revenue derived from purchasing products/services from that corporation during a certain period of time will generate X % in charitable donations

Over the years, several marketing researchers have determined that purchase-linked marketing is most effective when the beneficiary cause/organization is highly-personally relevant to the consumer: the more a cause/organization is personally relevant, the more effective is the marketing program.

Currently most merchants and group buying websites that adopt purchase-linked marketing techniques donate a portion of their revenue to a cause/organization of their choosing. Some merchants or group buying web sites allow buyers to select a different nonprofit as the beneficiary of the donation.

There is no known current online group-buying system that ties a specific deal with a specific cause/organization, while empowering the customer (or user) to replace the current benefiting organization (e.g., a nonprofit) with another benefiting organization (for example, a benefiting organization that is personally relevant to the user).

There is no known current online group-buying system that allows consumers and nonprofits to alter the beneficiary cause/organization of a specific promotion (or deal) and then further promote the altered deal. The ones that allow consumers to choose the recipient of the donation do so in a transient way valid only for the single sale.

There is no known current online group buying system that allows consumers to donate the savings resulting from the purchase of a discounted deal to a charitable cause/organization. All online group buying systems that include a donation in their business model donate a percentage of the revenue related to the sale and do not allow consumers to donate their savings.

There is no known current system where a corporate sponsor can advertise their philanthropic program connected to the donations generated by consumers purchasing a specific offer from a group buying web site.

There is no known current system where a group buying web site offers deals at 100% discount. Currently some group web buying sites may offer free deals in connection with performance, e.g., if a user refers N friends and they buy the deal, the user's deal is free.

There is no known current online group buying system that provides on a single coupon all of the logos and names of the business, the nonprofit organization, and the optional sponsor, in addition to the logo and/or name of the service provider.

Accordingly, there exists a need in the art to overcome the deficiencies and limitations described hereinabove.

### SUMMARY OF THE INVENTION

Embodiments of the present invention relate to a method and system for generating merchant discount deals, and more specifically, a method and system for generating merchant discount deals having philanthropic advertising and associated donations to an organization. Embodiments of the present invention are directed to a system and methods to mutually satisfy a consumer with a discount and a related base donation to a nonprofit organization, a vendor with a purchase-linked philanthropic advertising outlet reaching new consumers, and a nonprofit organization with a new source of funding, and an optional new online venue for sponsors to support the organization. In embodiments, the system and methods also empower a referrer, which could be, for example, a consumer or a nonprofit, to change the offer by selecting a different cause or organization, e.g., their favorite cause or organization, and share/advertise the new combination between the discounted product or service and the recipient of the donation. Furthermore, in embodiments, the system and methods allow the consumer purchasing the offer to increase the base donation by adding all or part of the savings.

Embodiments of the present invention are directed to a method for generating one or more merchant discount deals having philanthropic advertising and associated donations to one or more organizations. The method comprises selecting one or more merchant offers and selecting the one or more organizations. Additionally, the method comprises creating the one or more merchant discount deals using a processor of a computing device, by associating an offer of the one or more offers with an organization of the one or more organizations, wherein each merchant discount deal has an associated discount to a user and a base donation amount to one of the one or more organizations. Further, the method includes creating a visual depiction of the one or more merchant discount deals for presentation to a user.

In embodiments, the visual depiction comprises displaying for each merchant discount deal: an identifier of the merchant, and an identifier of the one of the one or more organizations.

In additional embodiments, the one or more merchant discount deals comprises a prominent deal and one or more other deals.

In further embodiments, the prominent deal comprises an initial or default organization as a beneficiary of the deal.

In embodiments, the visual depiction comprises for the prominent deal: a price of the prominent deal, at least one of a value of the prominent deal and a discount of the prominent deal, and a base donation amount.

In additional embodiments, the method is further for executing a sale of at least one of the one or more merchant discount deals, wherein the method further comprises: receiving a user selection of one of the one or more merchant discount deals; one of receiving and not receiving a user indication of an amount of the associated discount to donate to the organization; and executing the sale of the at least one of the one or more merchant discount deals in dependence upon the user selection, and the user indication or an absence of the user indication

In further embodiments, the method additionally comprises receiving a user selection of an alternative organization to replace an initial or default organization prior to the executing.

In embodiments, the method also includes creating a deal voucher.

In additional embodiments, the deal voucher comprises: a merchant identifier, which identifies a merchant providing the one of the one or more merchant discount deals; and an organization identifier, which identifies of the one of the one or more organizations.

In further embodiments, the deal voucher further comprises a sponsor identifier, which identifies a sponsor.

In embodiments, the method further comprises receiving a user request to create a referral, creating the referral, receiving a user indication of one or more referral recipients, and transmitting the referral to the one or more referral recipients.

In additional embodiments, the referral is one of a deal referral and a nonprofit referral.

In further embodiments, the method also includes receiving a user selection of an alternative organization to replace an initial or default organization prior to the creating.

In embodiments, the base donation is provided by a service provider performing the method.

In additional embodiments, the method further comprises determining a user location, wherein a selection of the displayed one or more merchant discount deals is in dependence on the user location.

In further embodiments, the method also includes dynamically adjusting at least one of a total donation amount and a discount for a deal upon receiving a user indication of an amount of an initial associated discount to donate to the organization.

In embodiments, the method further comprises transmitting a notification of the one or more merchant discount deals to subscribers of a service.

Embodiments of the present invention are also directed to a system configured for generating one or more merchant discount deals having philanthropic advertising and associated donations to one or more organizations. The system comprises a deal creation tool configured for: receiving a selection of one or more merchant offers, and receiving a selection the one or more organizations. Further, the deal creation tool is configured for creating the one or more merchant discount deals using a processor of a computing device, by associating an offer of the one or more offers with an organization of the one or more organizations, wherein each merchant discount deal has an associated discount to a user and a base donation amount to one of the one or more organizations, and creating a visual depiction of the one or more merchant discount deals for presentation to a user.

In additional embodiments, the system further comprises an indication receiving tool configured for receiving a user selection of one of the one or more merchant discount deals and for receiving a user indication of an amount of the associated discount to donate to the organization, and a deal execution tool configured for executing a sale of at least one of the one or more merchant discount deals in dependence upon the user selection and the user indication.

In further embodiments, the system also includes a location determination tool configured for determining a user location, wherein a selection of the displayed one or more merchant discount deals is in dependence upon the user location.

In embodiments, the system further includes a location voucher/coupon tool configured for creating a deal voucher, wherein the deal voucher comprises: a merchant identifier, which identifies a merchant providing the one of the one or more merchant discount deals; and an organization identifier, which identifies of the one of the one or more organizations.

In additional embodiments, the system includes a referral tool configured for: receiving a user request to create a referral; creating the referral; receiving a user indication of one or more referral recipients; and transmitting the referral to the one or more referral recipients.

Embodiments of the present invention are also directed to a computer program product for generating one or more merchant discount deals having philanthropic advertising and associated donations to one or more organizations, the computer program product comprising a computer usable storage medium having readable program code embodied in the storage medium. The computer program product includes at least one component operable to: receive a selection of the one or more merchant offers; receive a selection of the one or more organizations; create the one or more merchant discount deals using a processor of a computing device, by associating an offer of the one or more offers with an organization of the one or more organizations, wherein each merchant discount deal has an associated discount to a user and a base donation amount to one of the one or more organizations; and create a visual depiction of the one or more merchant discount deals for presentation to a user.

### BRIEF DESCRIPTION OF THE DRAWINGS

For a more complete understanding of the invention, as well as other objects and further features thereof, reference may be had to the following detailed description of the invention in conjunction with the following exemplary and non-limiting drawings wherein:

FIG. 1 is a flowchart illustrating an exemplary overall process for executing a sale of a deal according to an embodiment of the present invention;

FIG. 2 is a flowchart illustrating an exemplary process for selecting a prominent deal (or offer) according to aspects of the present invention;

FIG. 3 is a flowchart illustrating an exemplary process for selecting a nonprofit according to aspects of the present invention;

FIG. 4 is a flowchart illustrating an exemplary process for creating a referral link according to aspects of the present invention;

FIG. 5 is a flowchart illustrating an exemplary process for filtering deals (or offers) according to aspects of the present invention;

FIG. 6 is an exemplary system environment for implementing aspects of the present invention;

FIG. 7 depicts an exemplary image generated by the present invention and displayed to a user in accordance with aspects of the present invention;

FIG. 8 depicts an exemplary “checkout” image generated by the present invention and displayed to a user in accordance with aspects of the present invention;

FIG. 9 is an illustration of an exemplary image displayed to the user that describes a prominent offer (or deal or promotion) in accordance with aspects of the present invention;

FIG. 10 is an illustration of an exemplary “buy now” image displayed to the user in accordance with aspects of the present invention;

FIG. 11 is an illustration of an exemplary “flip and share” image displayed to the user in accordance with aspects of the present invention;

FIG. 12 is an illustration of an exemplary “share now” image displayed to the user in accordance with aspects of the present invention; and

FIG. 13 illustrates an exemplary deal structure in accordance with aspects of the present invention.

### DETAILED DESCRIPTION OF THE INVENTION

The present invention relates to a method and system for generating merchant discount deals, and more specifically, a method and system for generating merchant discount deals having philanthropic advertising and associated donations to an organization. The present invention is directed to a system and methods to mutually satisfy: (1) a consumer with a discount, and a related base donation to a nonprofit organization; (2) a vendor with a purchase-linked philanthropic advertising outlet reaching new consumers; and (3) a nonprofit organization with a new source of funding, and an optional new online venue for sponsors to support the organization. In embodiments, the system and methods also empower a referrer, which could be, for example, a consumer or a nonprofit, to change the offer by selecting a different cause or organization, e.g., their favorite cause or organization, and share/advertise the new combination between the discounted product or service and the recipient of the donation. Furthermore, in embodiments, the system and methods allow the consumer purchasing the offer to increase the base donation by adding all or part of the savings.

### Creating the Deal

In embodiments, the present invention is directed to a system and method that link a specific discount offer for goods and/or services from a merchant to a particular cause/organization that includes a base donation in the final sale price to consumers. In embodiments, the base donation may be provided by the service provider, the merchant, and/or a sponsor. The combination of the offer and the nonprofit benefiting from the donation is called, for example, a “Deal.”

In accordance with aspects of the invention, a deal may be created by a service provider comprising at least two parts: (1) a discounted offer from a business (or merchant); and (2) a donation to a nonprofit organization. Hence, the present invention is operable to link a specific deal to a specific nonprofit. Optionally, the deal includes: (3) a corporate sponsor (if there is one for that specific deal). Therefore, the present invention is operable to create a “coupon” (or voucher) bearing, for example, the logos and names of both the business and the nonprofit, and optionally, the corporate sponsor, along with a title of the offer and the logo and/or name of the service provider.

In embodiments, the present invention offers, for example, within an online setting, a showcase of daily deals that can be purchased by users to benefit a nonprofit organization linked to a specific deal. The “prominent deal” is the deal that is displayed in a prominent position on the screen (e.g., at the top or on the right side, or occupying a large portion of the displayed image) and, in embodiments, may be, for example, a deal geographically closest to the consumer or a deal referred through a deal referral (discussed below).

In embodiments, a deal may be fixed, such that a user cannot change the beneficiary (e.g., the nonprofit). For example, a merchant may require a deal be fixed as a condition of the merchant's participation. If the deal is not fixed, the present invention allows a user to change the default nonprofit to another selected nonprofit organization (e.g., another participating nonprofit organization). In embodiments, the systems enables a user to send notifications of the deals (or referrals) with the default nonprofit or a selected nonprofit to others, e.g., via email.

### Coupon/Voucher

In accordance with aspects of the present invention, in embodiments, the system is operable to provide a coupon bearing, for example, the name and/or logo of the merchant/business, the name and/or logo of the nonprofit and, the name and/or logo of the sponsor (if there is one), in addition to the name and/or logo of the system (e.g., the service provider), to create a clear graphic image of all parties involved in the transaction. To this point, in embodiments, when the system generates a coupon, the nonprofit's logo is included on the coupon and receives similar visibility as the business (or merchant) that offers the deal.

In embodiments, the coupon may be sent by the system to a user/buyer via email. The buyer may then, for example, present the coupon to the merchant (e.g., by displaying the coupon to a merchant or entering a coupon code, e.g., a voucher identifier, at a merchant website) to receive the discount deal.

In embodiments, a coupon may be valid for a limited duration (e.g., one week, one month, etc.). Upon passage of the limited duration, the voucher is invalid and cannot be redeemed. In embodiments, the system provides for the user to purchase a deal for another person, and send that person the coupon.

### Donating Savings

In embodiments, the present invention also enables consumers to donate the savings (or a portion thereof) resulting from purchasing deals online to the nonprofit cause/organization linked to the deal to augment the base donation already included in the sale price. The base donation is always guaranteed to be paid by another entity (e.g., a service provider) and if the consumer elects to keep their 100% savings, the base donation is the total donation. That is, as noted above, a base donation (for example, as a percentage of the sales price, e.g., 10% or 20%) may be provided by the service provider, the merchant, and/or a sponsor. Thus, if a customer purchases a deal, a base donation is provided to the designated nonprofit organization. In accordance with aspects of the invention, customers are presented with the option to increase the donation amount (i.e., augment the base donation) by donating all or part of their savings, for example, at the checkout page. For example, during the checkout process the user will have the possibility to donate their savings. If they choose not to donate, the service provider, for example, pays the base donation to the nonprofit. In embodiments, the system may be configured to allow a user to increase the donation by, for example, a percentage of the savings (i.e., the difference between the value of the good/service and the price offered for the good/service), for example, 10%, 20%, or 100%, amongst other contemplated amounts. In additional embodiments, a user may select any amount to donate. By implementing aspects of the present invention, consumers are able to convert their individual savings (nowadays saving, for example, $20, $50 or even $100) into micro-grants that, when pooled, can have a significant positive impact for a charitable cause/organization.

### Referral Links

In embodiments, the present invention is operable to generate referral links for visitors to a service provider website, and/or a subscribers, e.g., consumers and/or nonprofit organizations that have subscribed to utilize the present invention. For example, a visitor to the service provider website (in addition to, or instead of buying a deal) may decide to share a deal with others by sending a referral link, e.g., via email. In embodiments, the referral may be one of two kinds: a Deal Referral or a Nonprofit Referral. Additionally, in embodiments, the present invention is operable to allow consumers and nonprofits and/or subscribers to generate referral links (e.g., Deal Referrals and/or Nonprofit Referrals) with the default beneficiary altered to a new nonprofit (unless the deal is fixed) so that the new nonprofit benefits from the donations generated by the sales of the deal (as discussed below). In embodiments, the referral will show clearly who the sender is.

In embodiments, members (or subscribers) that have selected their favorite causes or nonprofit organizations in their profile may share/refer the organization to their friends. In this case, when their friends click on the referral link (e.g., a hyperlink) and arrive to the service provider web site, for example, the main deal that is presented to them is also changed to benefit the referred organization. However, these referrals may not be locked, and the user can change the beneficiary (e.g., the nonprofit organization) and share it with others.

In embodiments, deal referrals refer to specific combination (or pairing) of a merchant deal and a benefiting organization. With this type of referral, a user is referring others to the deal itself, (i.e., specific combination (or pairing) of the merchant deal and the benefiting organization). In essence, a user sending a deal referral is saying “check out this available deal.” For example, a user may see a particular merchant deal (e.g., chocolate), which benefits a particular organization (e.g., Labrador retriever nonprofit organization). With a deal referral, the user can send (or refer) this particular deal (with its specific pairing) to others who may have an interest in both chocolate and Labradors. In embodiments, any deal can be sent to others as a deal referral. As noted above, however, as long as the deal is not locked, a user may alter the beneficiary of the deal prior to sending the deal referral. That is, in accordance with aspects of the invention, a user can “create” a new deal and promote it using a deal referral.

Additionally, in embodiments, deal referrals may not be geographically limited or specific. For example, a deal referral generated by the system for a subscriber, and sent to someone in Miami, will generate for the consumer clicking on the referral link, an image of the specific deal and nonprofit linked to it as their “prominent deal,” regardless of the location of the deal and the consumer viewing the displayed deal.

In embodiments, nonprofit referrals are not specific for a single deal, but rather alter the determined “prominent deal” (and, in embodiments, all the other available deals) for the particular consumer viewing the displayed deal so that the deals are associated with the particular nonprofit identified by the nonprofit referral. With this type of referral, a user is referring others to support the designated benefiting organization by purchasing any deal, e.g., a prominent deal or another listed deal (all of which, in embodiments, have the organization designated by the nonprofit referral as the default nonprofit). In essence, a user sending a nonprofit referral is saying “help me support my chosen nonprofit with any of these available deals.” In embodiments, nonprofit referrals may be geographically limited or specific. For example, a nonprofit referral generated by the system for a subscriber, and sent to someone in San Francisco, will generate for the consumer clicking on the referral link, an image of the prominent deal, for example, a deal in San Francisco, e.g., a deal for a local store geographically close to the consumer, which is linked to the particular nonprofit identified by the nonprofit referral. Thus, the system creates an association between the local store and the particular nonprofit. In contrast, a nonprofit referral generated by the system for the same subscriber, e.g., the particular nonprofit, but sent to a potential consumer in Detroit, for example, will generate for the consumer clicking on the referral link, an image of a different deal, for example, a deal in Detroit, e.g., a deal for a Detroit store, while being linked to the same nonprofit. Thus, for example, for the consumer in Detroit, the system is operable to create an association, e.g., for the consumer, between the Detroit store and the particular nonprofit. Additionally, in embodiments, nonprofits can also place a nonprofit referral (e.g., a hyperlink) on their web site, since the nonprofit referral is not related to a specific deal.

### Changing Deal Association

In embodiments, the present invention is operable to enable consumers and nonprofit organizations to alter the default association between a discounted deal and a nonprofit cause/organization, and promote the new combination (i.e., the new Deal) to others, e.g., their friends and members. For example, in accordance with aspects of the invention, in embodiments, users have the option to change the nonprofit that is linked to the deal and select their favorite cause/organization. The user can purchase the modified deal and/or refer the modified (or new) deal to others. For example, the present invention enables the consumer to generate his/her own deal referral linking to a different cause/organization of their choosing, and further share it with their friends. As noted above, some deals may be “locked” and are not be changeable, such that the originally linked nonprofit is the only one that can benefit from donations generated by the sales of that specific deal.

If a user is a returning user or a member, in embodiments, the present invention may suggest a default nonprofit according to, for example, a business preference or the user's profile or recent purchases. The user can still change the nonprofit that would benefit from the coupon purchase. For example, members (or subscribers) that have selected their favorite causes in their profile are allowed to change the default cause/organization linked to the deal and, for example, send the new combination to their friends.

In embodiments, users can refer changed deals to their friends keeping the nonprofit they selected. A user can link a coupon to his/her favorite nonprofit and send an invitation to his/her friends with a link, e.g., to a website. When the user's friends click on the link they are taken directly to referred deal on the website, and find the nonprofit selected by the referrer as the default beneficiary of the coupon.

In essence, in accordance with an aspect of the present invention, the user has changed the deal to benefit their favorite nonprofit and promotes the newly created combination. This creates an incentive for users to promote deals.

In embodiments of the present invention, as long as a deal is not “locked,” a user can change the default nonprofit to another nonprofit (e.g., for purchasing and/or sending as referral). The invention also contemplates, however, an embodiment wherein a deal that has been changed (e.g., altered from a default nonprofit that was selected when the deal was originally created in the system), for example, by a subscriber through a deal referral, may be prevented (e.g., by the system) from being further altered by a downstream consumer unless the downstream consumer purchases the deal. For example, with this contemplated embodiment, a consumer who accesses a changed deal (e.g., by clicking on a deal referral link, e.g., a hyperlink, to access, e.g., a web site generated by the present invention) cannot further alter the deal unless, and until, the consumer purchases the changed deal. For example, the “prominent deal” that is presented to the consumer remains permanently linked to the nonprofit indicated in the referral, unless, and until, the particular consumer purchases the deal. With this contemplated embodiment, when a deal is “flipped” and shared, the people receiving it cannot change it again unless they buy it first.

### Sponsorship

In embodiments, the present invention is operable to allow sponsors (e.g., corporate sponsor, individual sponsor, foundation sponsor, and/or other company sponsor, amongst other sponsors) to be matched with causes/organizations and to offer to increase donations generated by consumers that benefit the sponsored organizations by purchasing deals online. In embodiments, sponsors may be tied to an organization and displayed when the organization is displayed. In embodiments, an organization can have multiple sponsors active in different geographic areas, in which case the sponsor to show may be selected relative to the viewer's location.

In embodiments, the present invention is operable to select a sponsor affiliated with a nonprofit causes/organizations linked to the deals and display the corporate sponsor on the screen when a deal is selected and viewed as the prominent deal. In further embodiments, a particular nonprofit organization may have the option to decline a sponsor, for example, if the sponsor's goals do not align with the particular nonprofit organization.

In embodiments, the system is operable to manage multiple sponsors for a particular nonprofit and select one of the multiple sponsors, for example, the sponsor that is most geographically relevant to a particular consumer viewing the web site. In embodiments, a geographically-relevant sponsor may be determined by, e.g., utilizing ZIP codes, GPS systems, amongst other contemplated methods. In further embodiments, a sponsor may simultaneously be a sponsor for a plurality of deals, for example, deals associated with a plurality of different nonprofits. For example, a single sponsor may agree to provide a matching donation for all of the donations collected by the service provider (for example, during a limited duration) regardless of the particular merchant deals and associated nonprofits.

In embodiments, the system is operable to calculate an additional donation pledged by the sponsor using, for example, rules determined by the sponsor in relation to, for example, the sponsor/nonprofit affiliation. In embodiments, pledge rules may include, for example: matching donations, donation awards, and several variations of the two that may be negotiated by each sponsor, amongst other contemplated pledge rules.

A matching donation is a donation in which the sponsor pledges to match (or, for example, double) a donation. Thus, a sponsor may double, triple or more the donations generated by consumers for the sponsored nonprofit. In embodiments, a sponsor may pledge any desired amount. In additional embodiments, a target amount may be used, wherein a sponsor matches, if, for example, the total amount of donations generated by consumers reaches a target amount within a certain period of time. In embodiments, the sponsor's pledge may be eligible for an unlimited period, or for a limited duration (for example, one, week, one month, one quarter, etc.) In further embodiments, a sponsor may agree to double a match, for example, if a non-profit is able register a target number (e.g., 100) of their members as subscribers to the service provider.

A donation award is when a sponsor pledges to donate a certain fixed amount if, for example, the total donations generated by consumers for the sponsored nonprofit reaches a target amount within a certain period of time.

### 100% Discount

In embodiments, the present invention is operable to allow merchants to benefit from offering 100% discounted offers designed to benefit a charitable cause/organization. The system is further operable to enable the consumer to donate from 0% to 100% of their savings to the linked cause/organization. The base donation is always guaranteed and if the consumer elects to keep their 100% savings, the base donation is paid by another entity. In embodiments, another entity may include the merchant, the sponsor and/or the service provider, amongst other contemplated entities.

This aspect of the present invention allows merchants and an operator of the present invention to offer essentially free products or services designed to benefit a specific cause/organization. A service provider can advertise and sell offers at 100% discount where the consumer doesn't have to spend any money and receives the coupon for free. During the checkout process they are encouraged to donate part or all of their 100% savings. For example, a merchant may offer a $10 mug for free (e.g., a limited amount of mugs). With this example, the user is receiving a $10 value for free, or $10 of savings. Then, for example, during the checkout process a user who accepts the free offer is encouraged to donate part or all of their $10 savings.

For example, in embodiments, a service provider may offer merchants the option to advertise a number of coupons (e.g., redeemable for a product) for free as part of an offer. Consumers can receive the advertised product or service at no cost. During the check out process they will have the option to donate some or all of their savings. Whether or not they choose to donate, the service provider pays the base donation to the nonprofit. An aim of this aspect of the present invention is to provide an incentive for users to register and to invite their friends as quickly as possible in order to benefit from the free deals before, for example, a limited supply runs out. A merchant offering 100% discount coupons that benefit a charitable cause doesn't risk diluting their brand because of the linked cause.

In accordance with aspects of the invention, in embodiments, nonprofit organizations, for example, can refer deals to their members and make themselves the recipient of the resulting donations. For example, users arriving at a website, by clicking on a link or website widget (e.g., a hyperlink) they received from a nonprofit, will find that the deals that can be changed (i.e., non-fixed deals) are now linked to benefit the referring nonprofit. In essence, in accordance with an aspect of the present invention, the nonprofit has changed the deal to benefit them and promotes the newly created combination. This creates an incentive for nonprofits to promote deals.

The present invention also contemplates that in some embodiments, newly added nonprofits may receive donations on the first deal only, until approved. For example, users can add a nonprofit organization that is not already part of a service provider's (of the present invention) network. As a result, the nonprofit benefits from the deal (e.g., receives the resulting donations) as any other organization already approved by service provider. However, the organization will not receive any benefit of a future deal until they are approved by the service provider. For example, a nonprofit organization that is not a subscriber of the service of the present invention cannot be selected to receive donations after the first deal. That is, a consumer can add a nonprofit that is not a subscriber and let them receive donation generated from the sale of the deal they selected them for. After that first deal, however, in embodiments, the nonprofit will have to agree to the service provider terms and subscribe to the system.

In accordance with aspects of the present invention, this system allows users to benefit their favorite nonprofits immediately, while also creating an incentive for newly added nonprofits to join the service provider's system to keep receiving donations.

In embodiments, the present invention may be operable to double a buyer's donation if the buyer refers the deal to a certain number of friends that buy the coupons. Implementing the present invention encourages buyers to promote a deal by pledging to double the referrer's donation if a certain number of people invited by the referrer end up buying the deal.

In embodiments, businesses offering deals using the present invention may increase sales by offering to donate additional money if, for example, a certain target is met. This aspect of the present invention allows merchants to encourage buyers to invite their friends and drive sales in order to increase the donation that benefits the nonprofit cause/organization.

### Subscribers

In accordance with additional aspects of the invention, a subscriber is a user who has registered (or subscribed) with a service provider who, for example, facilitates a website in accordance with aspects of the invention. In order to subscribe, a user may provide to the service provider, for example, one or more of: an email address, contact information, credit card information, and favorite nonprofits, amongst other contemplated subscriber information. In embodiments, a subscriber may receive, for example, daily, an indication (e.g., via email) of the daily deals. If a subscriber has indicated nonprofit preferences, or purchased a deal benefiting a particular nonprofit, when viewing deals on the website, the system will present the subscriber with these preferred (or previously used) nonprofits displayed more prominently for easier selection by the subscriber. Additionally, in embodiments, the system of the present invention may keep track of a subscriber's purchased coupons (or vouchers), and for example, send the subscriber a reminder if an expiration date of a coupon is approaching. Furthermore, the present invention is operable to store a subscriber's billing information and shipping information.

### Real Time Dynamic Presentation

In accordance with additional aspects of the invention, the service provider may provide a website, which includes a real-time (or substantially real-time) dynamic presentation of other users' activities. For example, in embodiments, the present invention may provide a list (e.g., FIFO running list) of other users' activities, purchases, new deal creations (or “flips”), and becoming subscribers, amongst other contemplated user activities.

### Flow Diagrams

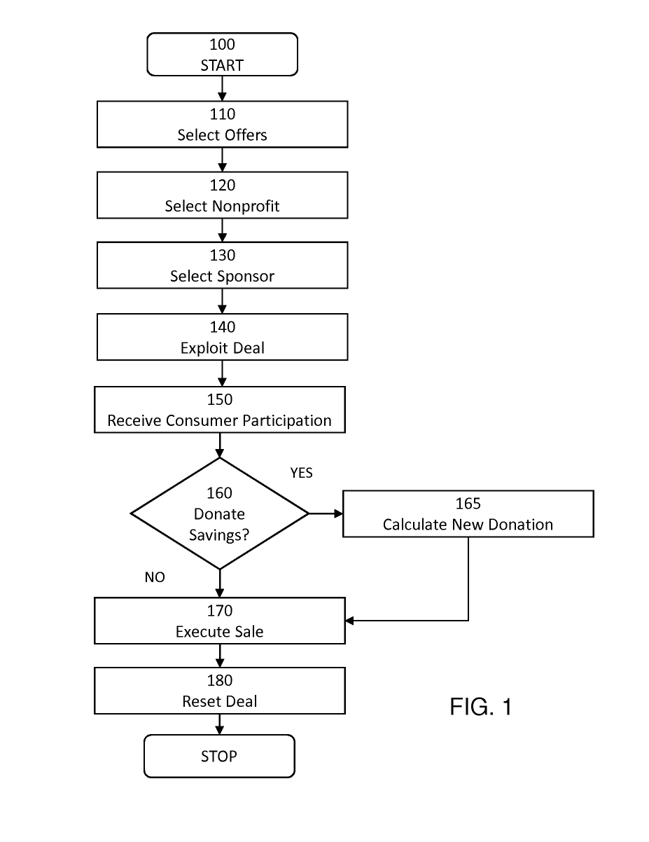

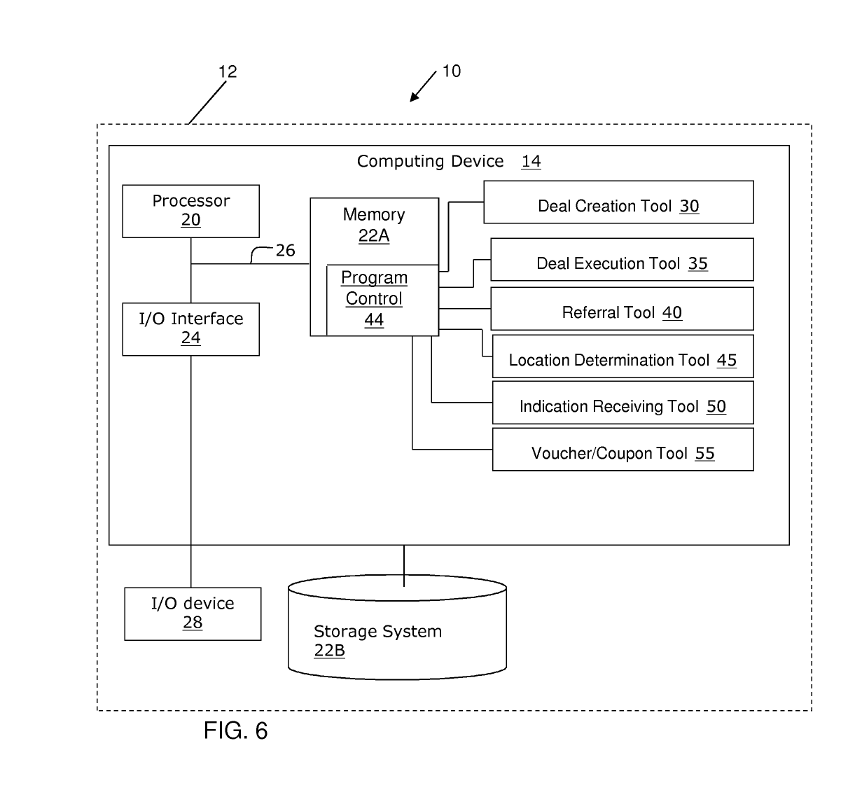

FIGS. 1-5 show exemplary flows for performing aspects of the present invention. The steps of FIGS. 1-5 may be implemented in the environment of FIG. 6, for example. The flow diagrams may equally represent high-level block diagrams of the invention. The flowcharts and/or block diagrams in FIGS. 1-5 illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Each block of each flowchart, and combinations of the flowchart illustrations can be implemented by special purpose hardware-based systems that perform the specified functions or acts, or combinations of special purpose hardware and computer instructions and/or software, as described above. Moreover, the steps of the flow diagrams may be implemented and executed from either a server, in a client server relationship, or they may run on a user workstation with operative information conveyed to the user workstation. In an embodiment, the software elements include firmware, resident software, microcode, etc.

Furthermore, the invention can take the form of a computer program product accessible from a computer-usable or computer-readable medium providing program code for use by or in connection with a computer or any instruction execution system. The software and/or computer program product can be implemented in the environment of FIG. 6. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disc—read/write (CD-R/W) and DVD.

### Executing Sale of Deal

FIG. 1 is a flowchart illustrating an exemplary overall process for executing a sale of a deal according to aspects of the present invention. Steps for the exemplary process of FIG. 1 include:

Step 100. START: The system may be activated by a user visiting the web site of a service provider. A user may enter the web site, for example, in two ways: directly (e.g., the user clicked on a simple link or typed the address of the service provider), or through a referral (e.g., the user clicked on a referral link sent, for example, via email, or a social networking link).

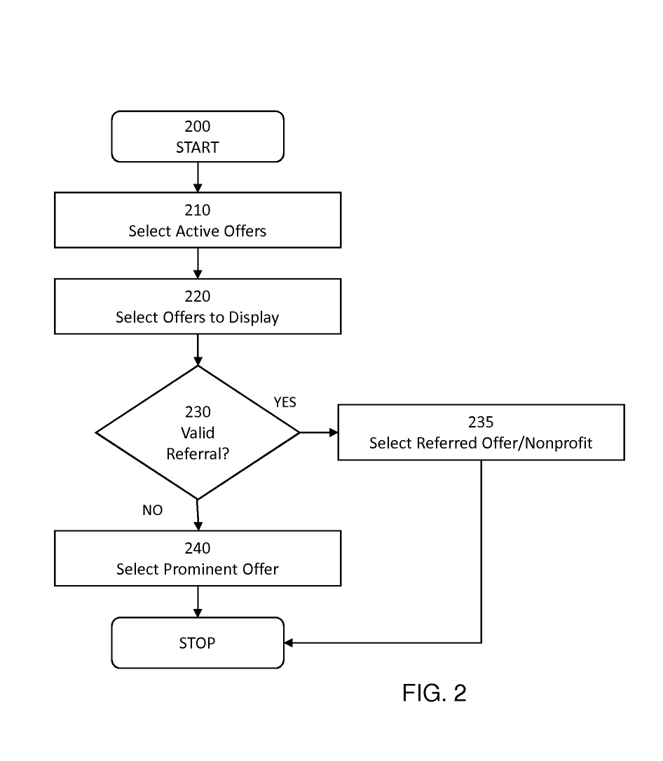

Step 110. Select Offers: The system selects the offers to display to the user using, for example, the steps in FIG. 2 (discussed below) using, for example: A) offer validity; B) referral link information, if present; and/or C) consumer's location determined, for example, using the consumer's ZIP code if available or a process known as “IP geolocation.”

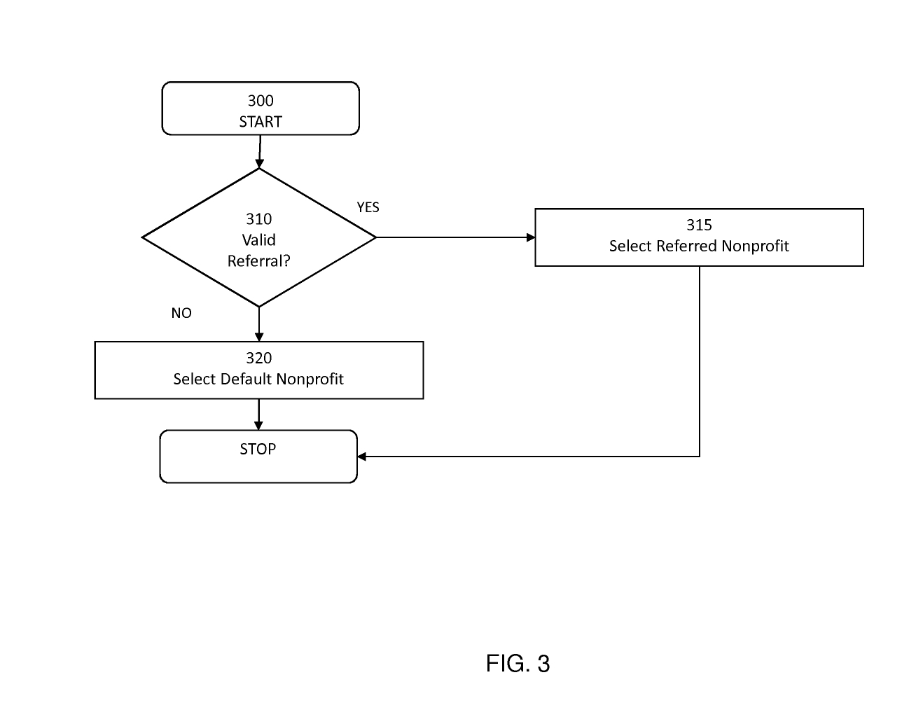

Step 120. Select Nonprofit: The system selects the nonprofit to associate with the prominent offer following, for example, the steps in FIG. 3 (discussed below) using: A) referral link information, if present; B) default nonprofit associated with the offers selected at step 110; C) a rotating basis; and/or D) randomly, amongst other contemplated selection approaches.

Step 130. Select Sponsor: The system selects the sponsor (if any) associated with the nonprofit organization selected at step 120 using: A) valid sponsors associated to the selected nonprofit; and B) consumer's geographic location in conjunction with the sponsor's geographic coverage, amongst other contemplated selection factors.

Step 140. Exploit Deal: The system exploits the resulting deal by displaying it to the consumer, for example, on a web site. The system displays the prominent deal in a prominent location on the screen, while the remaining selected deals may be displayed in a list ordered, for example, by their geographic vicinity to the consumer.

Step 150. Receive Consumer Participation: The system collects consumer's information necessary to complete the deal, including, e.g., billing address and credit card information. Consumer has the option to donate part or all of the savings associated with the offer in addition to the base donation.

Step 160. Donate Savings?: The system allows the consumer to increase the base donation by decreasing the savings associated with the offer.

Step 165. Calculate New Donation: The system calculates the new total donation and presents it to the consumer to finalize the sale.

Step 170. Execute Sale: In embodiments, the system charges the consumer's credit card immediately, generates a voucher (or coupon) that the consumer can use to redeem the good or service purchased, and adds the donation to the recipient nonprofit organization's account.

Step 180. Reset deal: The system resets the association to the nonprofit to the default cause/organization that was originally entered in the system when the deal was created. Resetting the deal allows a consumer to create a new combination offer/nonprofit and share it with their friends.

### Selecting a Prominent Deal

FIG. 2 is a flowchart illustrating an exemplary process for selecting a prominent deal (or offer) according to aspects of the present invention. In embodiments, the prominent deal may be displayed (for example, on a website) in a prominent position, e.g., on the top of the webpage. Steps for the exemplary process of FIG. 2 include:

Step 200. START: The system may be activated by a request to return a list of valid offers, each one linked to a cause/organization designated to receive the donation generated by the sale of the deal, in order of relevance, with the prominent offer (the one to show to the user in a prominent position on the screen), for example, at the top of a list of offers.

Step 210. Select Active Offers: The system selects from a database all the offers that are active for the current date.

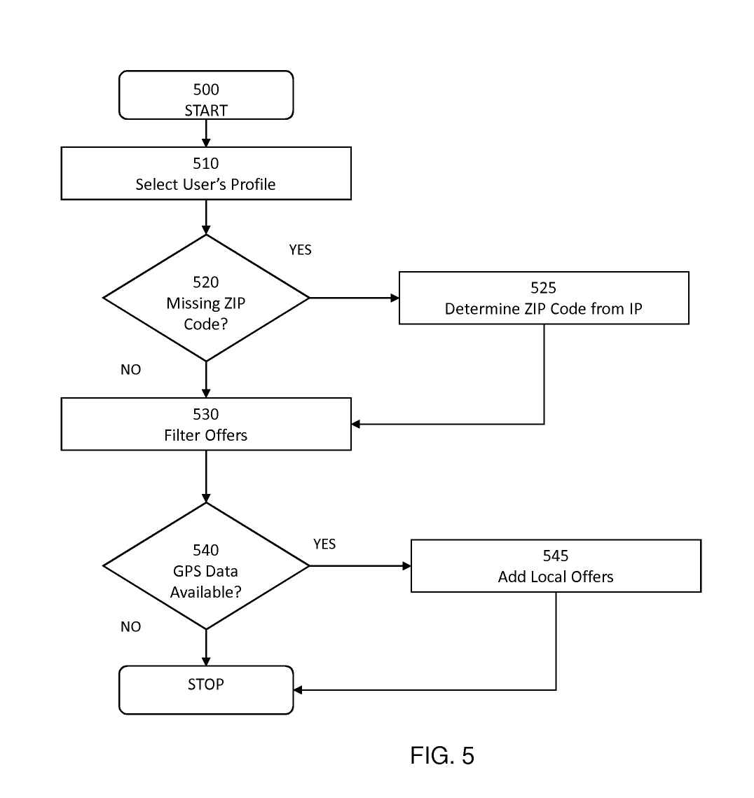

Step 220. Select Offers to Display: The system determines the offers to display to the consumer by, for example, matching the consumer's preferences and location with each selected offer, for example, according to FIG. 5.

Step 230. Valid Referral?: If the system detects that the consumer arrived to the web site by, for example, clicking on a valid referral link (e.g., a deal referral containing a specific combination offer/nonprofit, or a nonprofit referral), it processes the referral information at step 235.

Step 235. Select Referred Offer/Nonprofit: The system extracts the information from the referral link to identify the referred deal and/or nonprofit. The referred offer and/or nonprofit is added at the top of the list of selected offers. With a deal referral, the specific offer (i.e., the merchant deal in combination with the benefiting nonprofit) will be provided as the prominent deal. With a nonprofit referral, the system may provide one or more offers having the nonprofit as the default beneficiary, one of which is provided as the prominent deal.

Step 240. Select Prominent Offer: With a deal referral, the specific offer (i.e., the merchant deal in combination with the benefiting nonprofit) will be provided as the prominent deal. With a nonprofit referral, the system may provide one or more offers having the nonprofit as the default beneficiary, one of which is provided as the prominent deal (e.g., most geographically-relevant). The system, in absence of a referral link, for example, selects the offer closest (e.g., most geographically-relevant) to the consumer as the prominent offer at the top of the list.

### Selecting a Nonprofit

FIG. 3 is a flowchart illustrating an exemplary process for selecting a nonprofit as a beneficiary of a deal according to aspects of the present invention. Steps for the exemplary process of FIG. 3 include:

Step 300. START: The system may be activated, for example, by a user request to select the cause/organization to designate as the recipient of the donation (i.e., the beneficiary) resulting from acceptance of a specific offer.

Step 310. Valid Referral?: If the system detects that the consumer arrived to the web site by, for example, clicking on a valid referral link indicating a specific nonprofit, it processes the referral information at step 315.

Step 315. Select Referred Nonprofit: The system changes the offer by changing the associated nonprofit to the nonprofit organization indicated in the referral link.

Step 320. Select Default Nonprofit: In absence of a referral link, the system leaves the deal unchanged.

### Creating a Referral Link

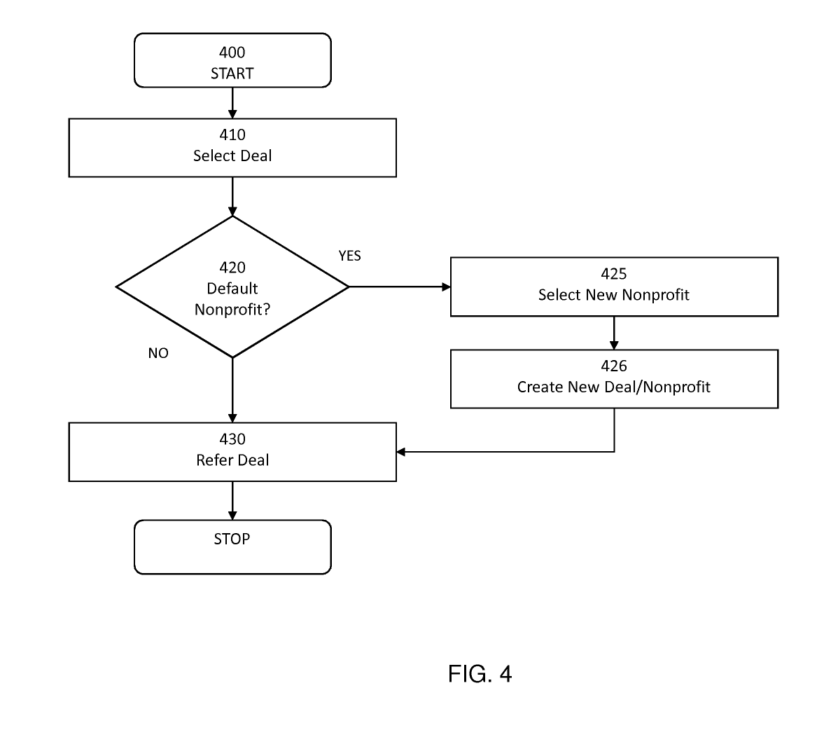

FIG. 4 is a flowchart illustrating an exemplary process for creating a referral link according to aspects of the present invention. Steps for the exemplary process of FIG. 4 include:

Step 400. START: The system is activated by a request to create a referral link to an offer in order to share the link with other users through emails, web pages, social media, etc.

Step 410. Select Deal: The system selects the deal indicated by the user.

Step 420. Default Nonprofit?: User selects whether to accept the default nonprofit.

If, yes at step 420, at step 425. Select New Nonprofit: The system receives a selection of the cause/nonprofit indicated by the user.

Step 426. Create New Deal/Nonprofit: The system creates a new combination between the offer and the cause/nonprofit designated to receive the donation resulting from the sale of the deal.

Step 430. Refer Deal: The system generates a new referral link to be shared with other users.

### Filtering Deals

FIG. 5 is a flowchart illustrating an exemplary process for filtering deals (or offers) according to aspects of the present invention. Steps for the exemplary process of FIG. 5 include:

Step 500. START: The system is activated, for example, by a request (e.g., a service provider or user) to filter a list of valid offers by matching the current user's profile with each offer's properties: area of validity and linked cause/nonprofit.

Step 510. Select User's Profile: The system loads the user's profile from the database and determines, for example, the user's ZIP code and favorite causes/nonprofits.

Step 520. Missing ZIP Code?: If the system cannot find the user's ZIP code in the user's preferences, it attempts to determine the user's location using the user's IP address at step 525.

Step 525. Determine ZIP code from IP: The system determines the user's ZIP code by using an IP-geolocation database or service.

Step 530. Filter Offers: The system creates a list of offers by calculating the distance between the user's ZIP code and each offer's area of validity (for example, one or more ZIP codes, or any other geographic designation, which could include, for example, the entire nation or world) and/or by matching the user's favorite nonprofits with the default (or fixed) nonprofit linked to each offer.

Step 540. Is GPS data available?: The system determines if user location date (e.g., GPS data) is available for the current user, e.g., the user is operating a mobile device with a GPS chip or any other device (a tablet, for example) that provides GPS services.

Step 545. Add Local Offers: The system adds to the selected offers list all the offers that qualify by calculating the distance between the user's GPS location and each offer's area of validity.

### System Environment

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized (e.g., one or more tangible computer readable mediums and/or intangible computer readable mediums). The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following:
an electrical connection having one or more wires,
a portable computer diskette,
a hard disk,
a random access memory (RAM),
a read-only memory (ROM),
an erasable programmable read-only memory (EPROM or Flash memory),
an optical fiber,
a portable compact disc read-only memory (CD-ROM),
an optical storage device,
a transmission media such as those supporting the Internet or an intranet, and/or
a magnetic storage device.

In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network. This may include, for example, a local area network (LAN) or a wide area network (WAN), or the connection may be made to an external computer (for example, through the Internet using an Internet Service Provider).

FIG. 6 shows an illustrative environment 10 for managing the processes in accordance with aspects of the invention. To this extent, the environment 10 includes a server or other computing system 12 that can perform the processes described herein. In particular, the server 12 includes a computing device 14. The computing device 14 can be resident on a network infrastructure or computing device of a third party service provider (any of which is generally represented in FIG. 6).

The computing device 14 includes a deal creation tool 30, a deal execution tool 35, a referral tool 40, a location determination tool 45, an indication receiving tool 50, and a voucher/coupon tool 55 to carry out aspects of the present invention. The deal creation tool 30, the deal execution tool 35, the referral tool 40, the location determination tool 45, the indication receiving tool 50, and the voucher/coupon tool 55 can be implemented as one or more program code in the program control 44 stored in memory 22A as separate or combined modules.

The computing device 14 also includes a processor 20, memory 22A, an I/O interface 24, and a bus 26. The memory 22A can include local memory employed during actual execution of program code, bulk storage, and cache memories which provide temporary storage of at least some program code in order to reduce the number of times code must be retrieved from bulk storage during execution. In addition, the computing device includes random access memory (RAM), a read-only memory (ROM), and an operating system (O/S).

The computing device 14 is in communication with the external I/O device/resource 28 and the storage system 22B. For example, the I/O device 28 can comprise any device that enables an individual to interact with the computing device 14 or any device that enables the computing device 14 to communicate with one or more other computing devices using any type of communications link. The external I/O device/resource 28 may be for example, a handheld device, PDA, handset, keyboard etc.

In general, the processor 20 executes computer program code (e.g., program control 44), which can be stored in the memory 22A and/or storage system 22B. Moreover, in accordance with aspects of the invention, the program control 44 having program code controls above-noted deal creation tool 30, deal execution tool 35, referral tool 40, location determination tool 45, indication receiving tool 50, and voucher/coupon tool 55. While executing the computer program code, the processor 20 can read and/or write data to/from memory 22A, storage system 22B, and/or I/O interface 24. The program code executes the processes of the invention. The bus 26 provides a communications link between each of the components in the computing device 14.

The computing device 14 can comprise any general purpose computing article of manufacture capable of executing computer program code installed thereon (e.g., a personal computer, server, etc.). However, it is understood that the computing device 14 is only representative of various possible equivalent-computing devices that may perform the processes described herein. To this extent, in embodiments, the functionality provided by the computing device 14 can be implemented by a computing article of manufacture that includes any combination of general and/or specific purpose hardware and/or computer program code. In each embodiment, the program code and hardware can be created using standard programming and engineering techniques, respectively.

Similarly, the computing infrastructure 12 is only illustrative of various types of computer infrastructures for implementing the invention. For example, in embodiments, the server 12 comprises two or more computing devices (e.g., a server cluster) that communicate over any type of communications link, such as a network, a shared memory, or the like, to perform the process described herein. Further, while performing the processes described herein, one or more computing devices on the server 12 can communicate with one or more other computing devices external to the server 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

In embodiments, the invention provides a business method that performs the steps of the invention on a subscription, advertising, and/or fee basis. That is, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

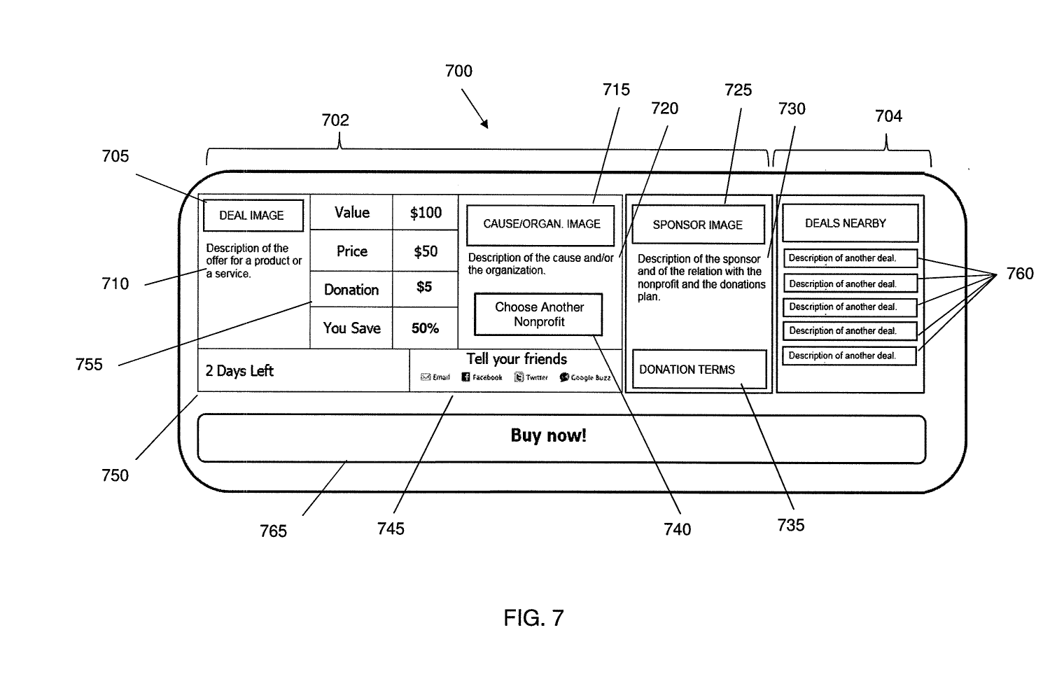

FIG. 7 depicts an exemplary image 700 generated by the present invention and displayed to a user of the present invention. As shown in FIG. 7, the image 700 includes a prominent offer (or deal) 702 and an additional deals display 704, including one or more additional deals 760. In embodiments, the deal image 705 may be an artistic representation, e.g., photograph, of the product or services offered, and may also include the merchant's name and/or logo. A textual description 710 of the offer for the product or service may also be displayed. In embodiments, the cause/organization image 715 may include an artistic representation of the charitable organization that will receive the donations generated by the sales of the coupon, and may also include the name and visual representation of a cause and the name and/or logo of the nonprofit organization. A textual description 720 of the charitable organization and/or cause that will receive the donation may also be displayed. In embodiments, the sponsor image 725 may include an artistic representation of the sponsor (if there is a sponsor) and may include the sponsor's name and/or logo. A textual description 730 of the sponsor, the relation with the nonprofit and/or the donations plan may also be displayed. The present invention is further operable to display the sponsor donation terms 735.

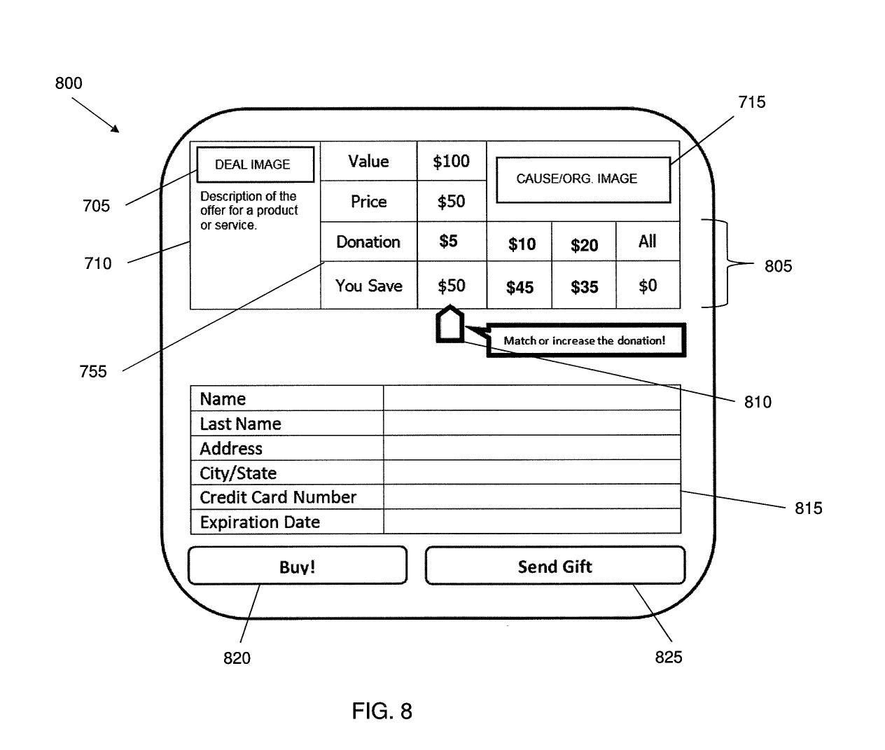

As shown in FIG. 7, in accordance with aspects of the present invention, the system is operable to provide a “choose another nonprofit” button 740 to allow the user to select another nonprofit to become the beneficiary for the same product or service offered. Additionally, the system is operable to provide the user an interface 745 to share the deal (e.g., send a deal referral) via email, and social media. The deal duration 750 indicates the remaining time before the deal is no longer available. While not illustrated in FIG. 7, in embodiments, for example, if there are a limited amount of deals, the system may indicate a remaining number of deals. The image 700 also includes a visual depiction of the deal cost details 755, which include a value of the deal, a price for the deal, a base donation amount contributed by a third party (e.g., the service provider) to the nonprofit, and money saved, i.e., (value-price), or percentage save, i.e., ((value-price)/value). In embodiments, the base donation may be determined as a percentage of the price (e.g., 10%). The image 700 also includes a “Buy now” button 765, which is operable to select the prominent deal 702 for purchase. In embodiments, actuating button 765 may link the user to the exemplary checkout image of FIG. 8.

FIG. 8 depicts an exemplary “checkout” image 800 generated by the present invention and displayed to a user of the present invention. As shown in FIG. 8, the checkout image 800 includes deal image 705, textual description 710 of the offer for the product or service, and cause/organization image 715. The checkout image 800 also includes deal cost details 755 and a donation/savings grid 805 and a selector 810. By moving the selector 810, a user can select to increase the donation for the deal, by contributing a portion of (or all of their) savings. As shown in FIG. 8, the checkout image 800 also billing information input fields 815 for receiving a user's billing information. Checkout image 800 also includes a “Buy” button 820 for purchasing the selected deal, and a send gift button 825 for purchasing the selected deal and sending it as a gift.

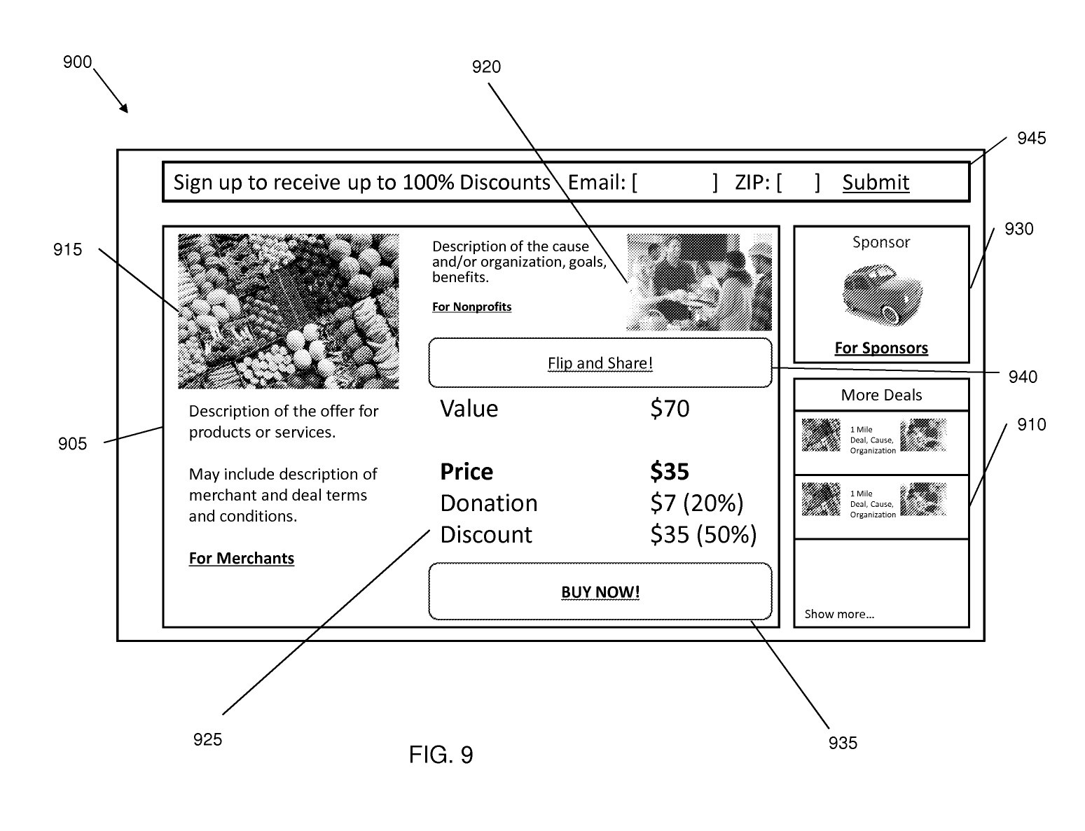

FIGS. 9-12 illustrate exemplary images displayed by a system implementing aspects of the present invention. FIG. 9 is an illustration of an exemplary image 900 displayed to the user that describes a prominent offer (or deal or promotion) 905 with a merchant offer/nonprofit combination to the user, a potential buyer. The user/buyer has the possibility to choose among a number of other available promotions (or deals) 910 that are available on the right panel. The prominent offer 905 includes a description 915 of the product or service being offered, the linked default nonprofit 920, the value and sale terms of the promotion 925, and the sponsor 930 (if any). In embodiments, the description of the sponsor 930 may include a description of the sponsorship: e.g., match donations after $1000.00. The image 900 also includes a “buy now” selector 935 for buying the promotion as is and linking the user to the charge page, and a “flip and share” selector 940 to send it to a friend with the same linked nonprofit 920, or with a different nonprofit. In embodiments, the “flip and share” selector 940 allows a user (e.g., a registered user) to change the nonprofit organization and share the deal without having to buy it first. As shown in FIG. 9, the image 900 also includes a sign-up area 945 (or registration fields), which enable a user to subscribe (or register) with the service provider. Additionally, in embodiments, the image 900 may also include a “scoreboard” (not shown), which quantifies the total money donated to the nonprofit organization.

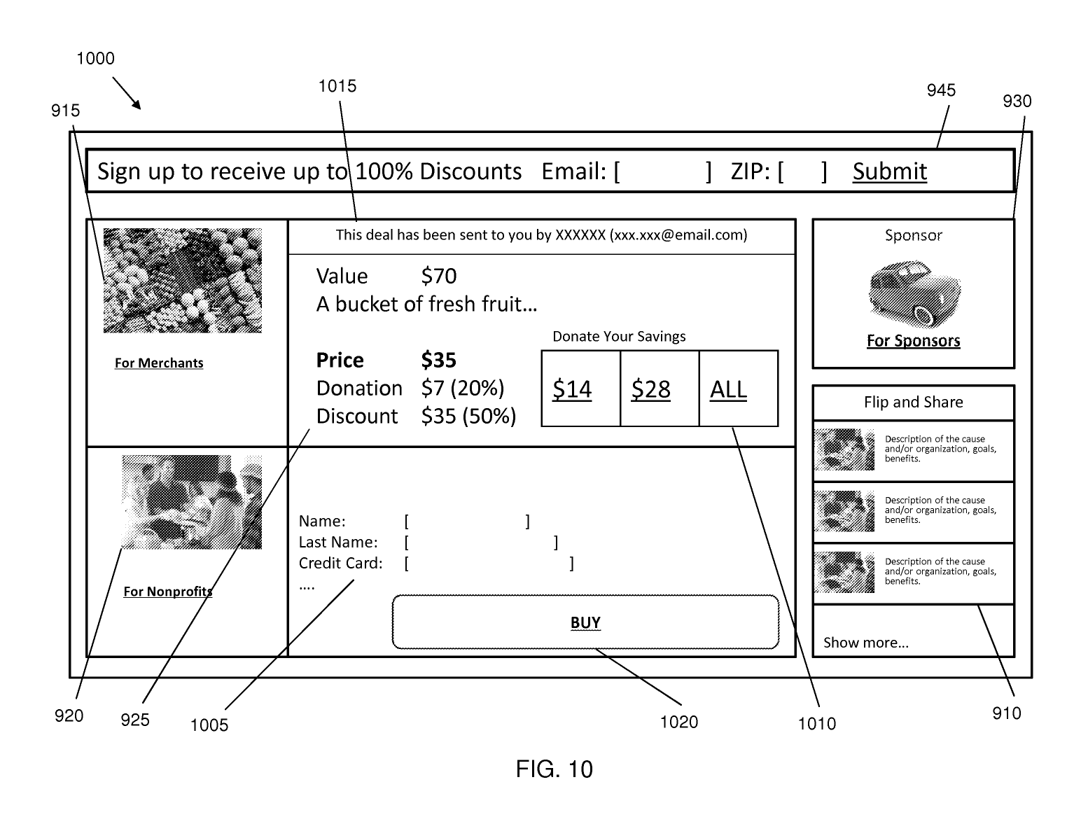

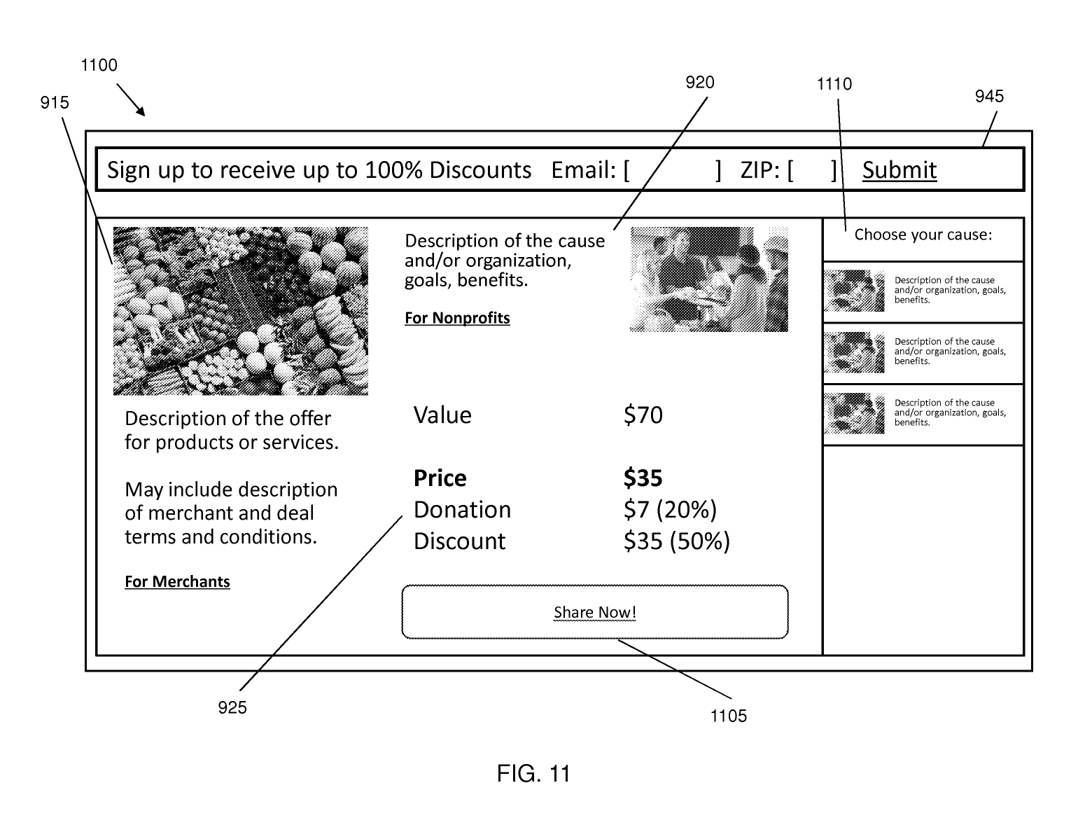

FIG. 10 is an illustration of an exemplary “buy now” image 1000 displayed to the user that describes what happens after an offer and nonprofit combination has been selected (e.g., by actuating the “buy now” selector 935 of FIG. 9). In accordance with aspects of the invention, a buyer can then purchase the promotion by entering the billing and shipping information (e.g., credit card information). As shown in FIG. 10, the image 1000 includes a description 915 of the product or service being offered, the linked default nonprofit 920, the value and sale terms of the promotion 925, the sponsor 930 (if any), the sign-up area 945, and a number of other available promotions (or deals) 910 that are available on the right panel. In embodiments, only one item in the list of other available promotions (or deals) 910 is highlighted at a time, with the first in the list being the default selection and highlighted initially. Additionally, image 1000 also includes billing information input fields 1005 for receiving a user's billing information. In accordance with aspects of the invention, image 1000 also includes donation/savings selector 1010, which allows a user to increase the donation for the deal, by contributing a portion of (or all of their) savings. With this exemplary embodiment, the underlined donation amounts ($14, $28, ALL) are clickable (e.g., with a mouse), and when clicked sale terms of the promotion 925 (e.g., the price, donation amount, and percentage) are updated dynamically. If the deal shown in image 1000 was sent via a referral, for example, the system is operable to provide an indication 1015 of who sent the referral. A buy button 1020 is operable to finalize the deal transaction and confirm the purchase. Additionally, in embodiments, actuating the buy button 1020 may link the user to the “flip and share” page (shown in FIG. 11) using the nonprofit organization selected. In embodiments, sharing the deal with others may be performed after the purchase of a deal is completed.

FIG. 11 is an illustration of an exemplary “flip and share” image 1100 displayed to the user when a user opts to share an offer with friends and family (e.g., by pressing ‘“flip and share” button 940 of FIG. 9). The system of the present invention presents the buyer with the option to share the offer with the default linked nonprofit 920, or change the nonprofit through the cause selection panel 1110 on the right. Once the desired combination offer and nonprofit has been selected the buyer can click the share button 1105 to initiate the share process, e.g., via email or social media. As also shown in FIG. 11, image 1100 includes a description 915 of the product or service being offered, the linked default nonprofit 920, the value and sale terms of the promotion 925, and the sign-up area 945.

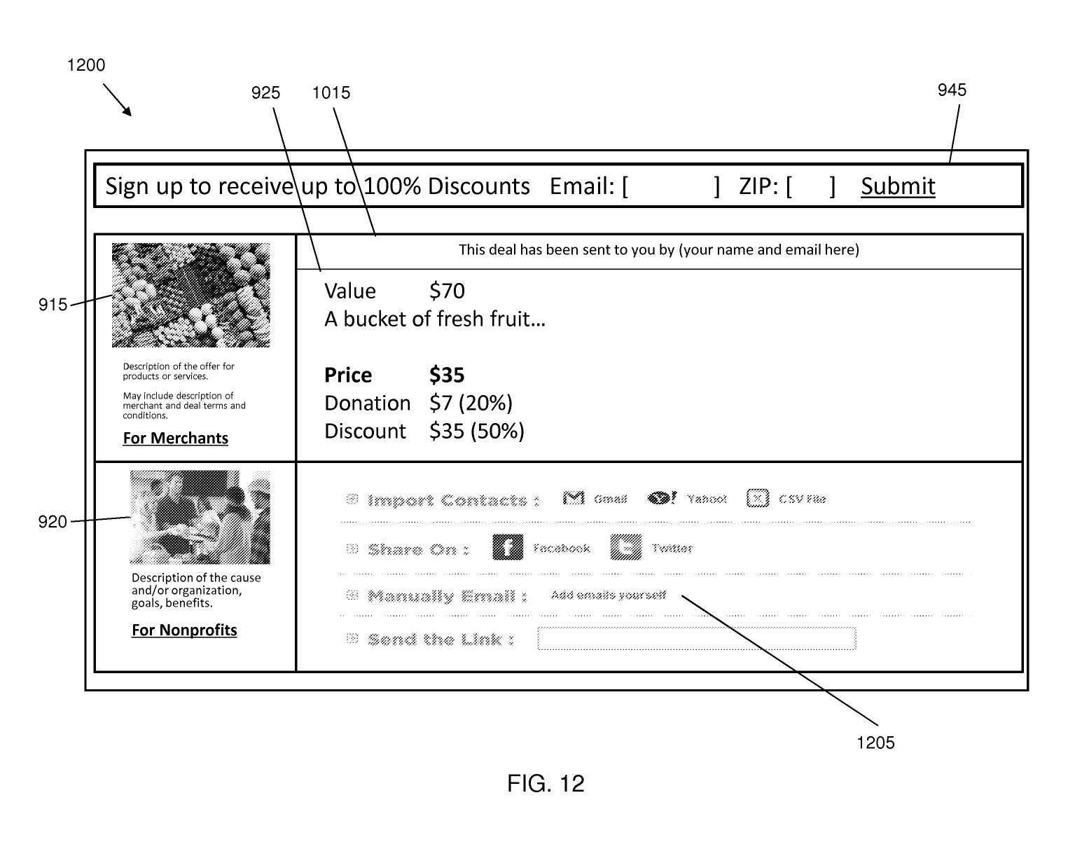

FIG. 12 is an illustration of an exemplary “share now” image 1200 displayed to the user when a user chooses to share the offer with friends and family (e.g., by actuating the “share now” button 1105 of FIG. 11). The buyer is presented with the possibility of choosing the sharing media among several email and social media options 1205. As also shown in FIG. 12, image 1200 includes a description 915 of the product or service being offered, the linked default nonprofit 920, the value and sale terms of the promotion 925, the sign-up area 945, and an indication 1015 of who sent the referral.

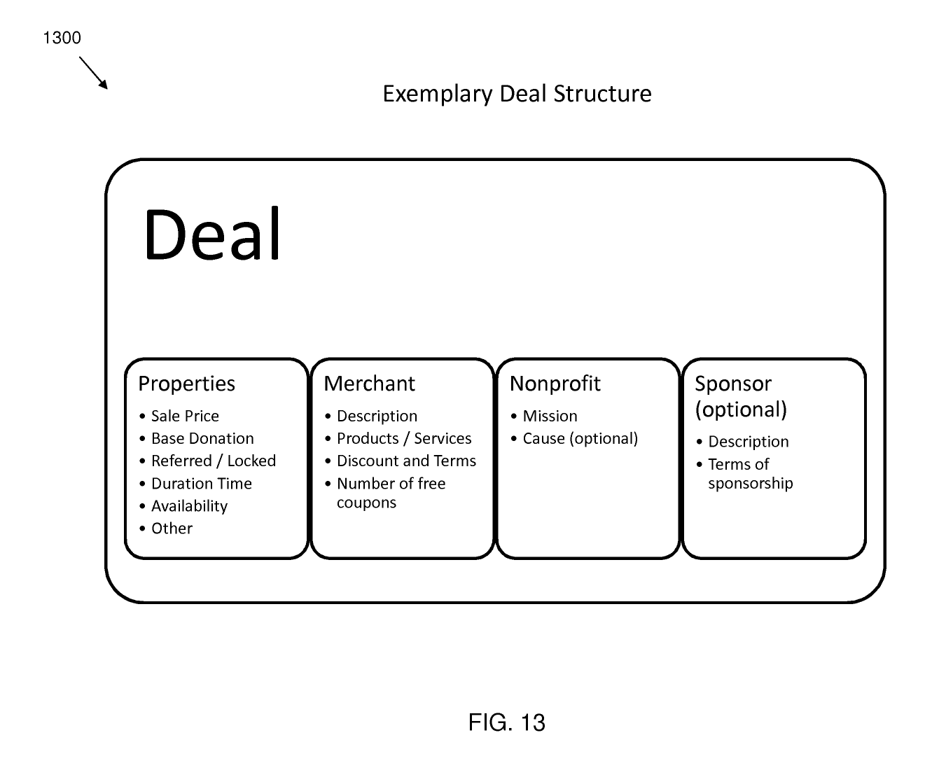

FIG. 13 illustrates an exemplary deal structure 1300 in accordance with aspects of the present invention. In embodiments, elements of the deal structure 1300 may include properties, merchant elements, nonprofit elements, and sponsor elements (if there is a sponsor). Properties define a product or service being offered for sale, and may include: the sale price, which is the price a buyer pays to purchase the product or service; the base donation, which is the base amount that is being donated (e.g., by the service provider) to the nonprofit with the transaction (e.g., determined as a percentage of the sale price); a referred/locked element, which indicates whether the nonprofit/merchant combination is a referred (or default) combination, or a locked combination (e.g., the merchant had requested for the beneficiary of the offer, e.g., the nonprofit, not be changed or “flipped”); a duration/time, which is duration of the deal (or offer), for example, a number of days the offer is active or available at a service provider website; availability, which is a number of vouchers (e.g., a limited quantity) made available by the merchant; and other, which encompasses any other information collected for the sale.

In embodiments of the present invention, elements of the merchant may include: a description, which includes an explanation of the merchant's activity; product/services, which includes a detailed explanation of the product and services being offered; discount and terms, which may include the features and restrictions on the offer (e.g., one per customer); and a number of free coupons (e.g., 100% discount coupons, for example, to boost participation).

In embodiments of the present invention, elements of the nonprofit refers to the benefiting organization. Elements of the nonprofit may include: a mission statement, which may include a description of what the nonprofit does and how the donation is utilized; and a cause, which may include a description of the specific about current projects (optional).

In embodiments of the present invention, elements of the sponsor refer to the matching donor to match the collected donations (optional—if there is one). Elements of the sponsor may include: a description, which may include an explanation of what the sponsor does; and/or the terms of sponsorship, which may include a description of the terms of the sponsorship.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims, if applicable, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Accordingly, while the invention has been described in terms of embodiments, those of skill in the art will recognize that the invention can be practiced with modifications and in the spirit and scope of the appended claims.

For example, while the application discusses nonprofit organizations, the invention can be utilized with other organizations (e.g., for-profit organizations) that may, for example, be involved in a fundraising effort.

What is claimed is:

1. A method for generating one or more merchant discount deals having philanthropic advertising and associated donations to one or more organizations, the method comprising:
selecting one or more merchant offers;
selecting the one or more organizations;
creating the one or more merchant discount deals using a processor of a computing device, by associating an offer of the one or more offers with an organization of the one or more organizations, wherein each merchant discount deal has an associated discount to a user and a base donation amount to one of the one or more organizations; and
creating a visual depiction of the one or more merchant discount deals for presentation to a user.

2. The method of claim 1, wherein the visual depiction the one or more merchant discount deals comprises for each merchant discount deal:
an identifier of the merchant; and
an identifier of the one of the one or more organizations.

3. The method of claim 1, wherein the one or more merchant discount deals comprises a prominent deal and one or more other deals.

4. The method of claim 3, wherein the prominent deal comprises an initial or default organization as a beneficiary of the deal.

5. The method of claim 3, wherein the visual depiction of the one or more merchant discount deals comprises for the prominent deal:
a price of the prominent deal;
at least one of a value of the prominent deal and a discount of the prominent deal; and
a base donation amount.

6. The method of claim 1, wherein the method is further for executing a sale of at least one of the one or more merchant discount deals, the method further comprising:
receiving a user selection of one of the one or more merchant discount deals;
one of receiving and not receiving a user indication of an amount of the associated discount to donate to the organization; and
executing the sale of the at least one of the one or more merchant discount deals in dependence upon the user selection, and the user indication or an absence of the user indication.

7. The method of claim 6, further comprising receiving a user selection of an alternative organization to replace an initial or default organization prior to the executing.

8. The method of claim 1, further comprising creating a deal voucher.

9. The method of claim 8, wherein the deal voucher comprises:
a merchant identifier, which identifies a merchant providing the one of the one or more merchant discount deals; and
an organization identifier, which identifies of the one of the one or more organizations.

10. The method of claim 8, wherein the deal voucher further comprises a sponsor identifier, which identifies a sponsor.

11. The method of claim 1, further comprising:
receiving a user request to create a referral;
creating the referral;
receiving a user indication of one or more referral recipients; and
transmitting the referral to the one or more referral recipients.

12. The method of claim 11, wherein the referral is one of a deal referral and a nonprofit referral.

13. The method of claim 11, further comprising receiving a user selection of an alternative organization to replace an initial or default organization prior to the creating the referral.

14. The method of claim 1, wherein the base donation is provided by a service provider performing the method.

15. The method of claim 1, further comprising determining a user location, wherein a selection of the displayed one or more merchant discount deals is in dependence on the user location.

16. The method of claim 6, further comprising dynamically adjusting at least one of a total donation amount and a discount for a deal upon receiving a user indication of an amount of an initial associated discount to donate to the organization.

17. The method of claim 1, further comprising transmitting a notification of the one or more merchant discount deals to subscribers of a service.

18. A system configured for generating one or more merchant discount deals having philanthropic advertising and associated donations to one or more organizations, the system comprising:
a deal creation tool configured for:
receiving a selection of one or more merchant offers;
receiving a selection the one or more organizations;
creating the one or more merchant discount deals using a processor of a computing device, by associating an offer of the one or more offers with an organization of the one or more organizations, wherein each merchant discount deal has an associated discount to a user and a base donation amount to one of the one or more organizations; and
creating a visual depiction of the one or more merchant discount deals for presentation to a user.

19. The system of claim 18, further comprising:
an indication receiving tool configured for receiving a user selection of one of the one or more merchant discount deals, and for receiving a user indication of an amount of the associated discount to donate to the organization; and
a deal execution tool configured for executing a sale of at least one of the one or more merchant discount deals in dependence upon the user selection and the user indication.

20. The system of claim 18, further comprising a location determination tool configured for determining a user location, wherein a selection of the displayed one or more merchant discount deals is in dependence upon the user location.

21. The system of claim 18, further comprising a location voucher/coupon tool configured for creating a deal voucher, wherein the deal voucher comprises:
a merchant identifier, which identifies a merchant providing the one of the one or more merchant discount deals; and
an organization identifier, which identifies of the one of the one or more organizations.

22. The system of claim 18, further comprising a referral tool configured for:
receiving a user request to create a referral;
creating the referral;
receiving a user indication of one or more referral recipients; and
transmitting the referral to the one or more referral recipients.

23. A computer program product for generating one or more merchant discount deals having philanthropic advertising and associated donations to one or more organizations, the computer program product comprising a computer usable storage medium having readable program code embodied in the storage medium, the computer program product includes at least one component operable to:
receive a selection of the one or more merchant offers;
receive a selection of the one or more organizations;
create the one or more merchant discount deals using a processor of a computing device, by associating an offer of the one or more offers with an organization of the one or more organizations, wherein each merchant discount deal has an associated discount to a user and a base donation amount to one of the one or more organizations; and
create a visual depiction of the one or more merchant discount deals for presentation to a user.
